(19) United States
(12) Patent Application Publication
(10) Pub. No.: US 2013/0105389 A1
(43) Pub. Date: May 2, 2013

(54) WATER TREATMENT METHOD AND ULTRAPURE WATER PRODUCTION METHOD

(71) Applicants: Nobukazu Arai, Tokyo (JP); Tetsurou Fukase, Tokyo (JP); Tarou Iizumi, Tokyo (JP); Nozomu Ikuno, Tokyo (JP); Shigeki Fujishima, Tokyo (JP)

(72) Inventors: Nobukazu Arai, Tokyo (JP); Tetsurou Fukase, Tokyo (JP); Tarou Iizumi, Tokyo (JP); Nozomu Ikuno, Tokyo (JP); Shigeki Fujishima, Tokyo (JP)

(73) Assignee: KURITA WATER INDUSTRIES LTD., Tokyo (JP)

(21) Appl. No.: 13/643,199

(22) PCT Filed: Mar. 16, 2011
(86) PCT No.: PCT/JP2011/056309

§ 371 Date: Dec. 27, 2012

(30) Foreign Application Priority Data
Apr. 30, 2010 (JP) 2010-105151
Jul. 2, 2010 (JP) 2010-152325
Dec. 17, 2010 (JP) 2010-281570

(51) Int. Cl. C02F 3/34

(52) U.S. Cl. CPC C02F 3/34
USPC 210/610

(57) ABSTRACT

In a water treatment method, raw water supplied from a water supply reservoir for reserving the raw water is biologically treated by a biological treatment means before being supplied to a primary pure water apparatus. Thereafter, urea or a urea derivative and/or an ammoniacal nitrogen source (NH₃—N) are added before the biological treatment means. In such a treatment flow, it is preferred that a reduction treatment means is provided after the biological treatment means and before the primary pure water apparatus. According to the water treatment method, the TOC, in particular urea, in the raw water can highly be decomposed.

### TECHNICAL FIELD

The present invention relates to a water treatment method for raw water and an ultrapure water production method that uses the treated water treated by this water treatment method, and particularly to a water treatment method that can highly removes urea in raw water and an ultrapure water production method that uses the treated water treated by this water treatment method.

### BACKGROUND ART

Heretofore, an ultrapure water production apparatus, which produces ultrapure water from raw water such as city water, groundwater and industrial water, is basically comprised of a pretreatment apparatus, a primary pure water production apparatus and a secondary pure water production apparatus. Among them, the pretreatment apparatus comprises aggregation, floatation and filtration apparatuses. The primary pure water production apparatus comprises, for example, two reverse osmotic membrane separating apparatuses and a mixed-bed-type ion exchange apparatus, or an ion exchange pure water apparatus and a reverse osmotic membrane separating apparatus. Further, the secondary pure water production apparatus comprises, for example a low-pressure ultraviolet rays oxidation apparatus, a mixed-bed-type ion exchange apparatus and an ultrafiltration membrane separating apparatus.

In such an ultrapure water production apparatus, demands for improving the purity thereof is increasing, and TOC components are accordingly required to be removed. Among TOC components in ultrapure water, urea is particularly difficult to be removed, and therefore, removal of urea significantly affects the content rate of the TOC components as the TOC components are decreased. In this respect, Patent Documents 1 to 3 describe that urea is removed from water to be supplied to an ultrapure water production apparatus thereby sufficiently decreasing the TOC in ultrapure water.

Patent Document 1 discloses that a biological treatment apparatus is incorporated in a pretreatment apparatus and this biological treatment apparatus decomposes urea. In addition, Patent Document 2 discloses that a biological treatment apparatus is incorporated in a pretreatment apparatus, mixed water of water to be treated (industrial water) and recovered water from semiconductor washing is caused to pass therethrough, and organic substances contained in this recovered water from semiconductor washing act as a carbon source to enhance the decomposing rate of urea. Note that this recovered water from semiconductor washing may contain a large amount of ammonium ions (NH₄⁺), which may possibly act as a nitrogen source like urea to inhibit the decomposition of urea. Further, in order to reduce the above possibility derived from Patent Document 2, Patent Document 3 describes that water to be treated (industrial water) and recovered water from semiconductor washing are separately subjected to biological treatment before being mixed, and the mixed water is caused to pass through a primary pure water production apparatus and a secondary pure water production apparatus.

### PRIOR ART DOCUMENTS

### Patent Documents

[Patent Document 1] Published Patent Application No. H06-63592 (1994)

[Patent Document 2] Published Patent Application No. H06-233997 (1994)

[Patent Document 3] Published Patent Application No. H07-313994 (1995)

### SUMMARY OF THE INVENTION

### Problems To Be Solved By the Invention

If, however, a carbon source is added to water to be treated like the water treatment method described in Patent Document 2, then the urea-decomposing/removing efficiency in the biological treatment apparatus is improved, but the growing amount of bacteria bodies in the biological treatment apparatus may possibly increase to thereby also increase the outflow amount of bacteria bodies from that biological treatment apparatus.

In addition, according to the water treatment method described in Patent Document 2, ammonium ions may possibly inhibit the decomposition of urea if recovered water from semiconductor washing is used as a carbon source, in which a large amount of ammonium ions is contained.

The present invention has been created in view of the above one or more negative possibilities, and objects thereof include providing a water treatment method that can highly decompose TOC, particularly urea, in raw water. In addition, the present invention is for the purpose of providing an ultrapure water production method that utilizes the water treatment method.

### Means For Solving the Problems

First, in order to eliminate or reduce the above negative possibilities, the present invention provides a water treatment method for biologically treating raw water that contains an organic substance, wherein the water treatment method is characterized by comprising: adding urea or a urea derivative and/or an ammoniacal nitrogen source to the raw water; and thereafter performing a biological treatment for the raw water (Invention 1).

Removal of urea involves urea-decomposing bacteria (presumed as a kind of nitrifying bacteria). According to the above invention (Invention 1), the raw water is added thereto with urea or a urea derivative and/or an ammoniacal nitrogen source thereby to help the growth of nitrifying bacteria group which exists in the biological treatment apparatus and which decomposes urea, and excellent urea removability can thus be obtained.

That is, urea in the raw water significantly varies with seasons, but if the urea concentration in the raw water remains low during a long period of time (two weeks to one month or more), then the urea removability of the biological treatment apparatus considerably deteriorates and may not be responsible for the subsequent rise in the urea concentration. This appears to be because the activity of nitrifying bacteria group deteriorates or the nitrifying bacteria group gradually flows out from the apparatus. In this regard, according to the above invention (Invention 1), the raw water is added thereto with urea or one or more urea derivatives to thereby allow the minimum nitrifying bacteria group to be maintained even in the case where the urea concentration in the raw water decreases, and the urea removability can be maintained even when the urea concentration rises after remaining at low level over a long period of time.

In addition, the water treatment method described in Patent Document 2 is supposed to be of a treatment mechanism in which BOD assimilating bacteria (heterotrophic bacteria) rather than nitrifying bacteria, when decomposing/assimilating organic substances, decompose urea and urea derivatives as nitrogen sources to take therein as ammonia thereby removing urea and urea derivatives. In contrast, utilizing that the nitrifying bacteria group has a mechanism for removing urea and urea derivatives by oxidizing them to ammonia or directly to nitrous acid in a process where ammonia is oxidized to nitrous acid or nitric acid, the above invention (Invention 1) adds one or more ammoniacal nitrogen sources to the raw water thereby allowing the nitrifying bacteria group to grow and to enhance their activity. The nitrifying bacteria group with enhanced activity appears to improve the removability for urea and urea derivatives.

Moreover, in the above invention (Invention 1), the raw water is added thereto with urea or urea derivatives and ammoniacal nitrogen sources, so that the addition of ammoniacal nitrogen sources enhances the growth and the activity of nitrifying bacteria group while minimizing the adding amount of urea or urea derivatives, and higher advantageous effects can thus be obtained for load fluctuation. This is because of reasons as follows. That is, even during periods where the urea concentration in the raw water is reduced, adding ammoniacal nitrogen sources in the above invention (Invention 1) allows the activity of urea-decomposing bacteria to be maintained, and adding ammoniacal nitrogen sources in combination with a small amount of urea or urea derivatives allows for maintaining the minimum bacteria group suitable for removal of urea or urea derivatives. Hence, sufficient urea removability can be obtained even in the case where the urea concentration in the raw water rises after remaining at low level over a long period of time. Furthermore, urea and urea derivatives have a risk as residues in the biologically treated water and addition of excessive amount is thus not preferable, but the addition of ammoniacal nitrogen source can complement them.

It is preferred that the above invention (Invention 1) further comprises adjusting pH within a range of 5 to 6.5 to perform the biological treatment after adding the urea or the urea derivatives and/or the ammoniacal nitrogen sources to the raw water (Invention 2).

As a result of the subsequent research for a water treatment method in which ammoniacal nitrogen is added to the biological treatment thereby growing the nitrifying bacteria group (ammonia oxidizing bacteria group) to enhance the urea decomposing ability, it has been revealed that the nitrifying bacteria group can use oxidation of ammonia to generate energy to grow even without decomposing urea, and a certain operation condition may provide a system where only the added ammoniacal nitrogen is utilized and urea is not decomposed.

Specifically, the concentration of urea and urea derivatives is known as varying with seasons in city water and industrial water, and the activity of nitrifying bacteria group also varies depending on the concentration of urea and urea derivatives in the supplied water. More specifically, if the concentration of urea and urea derivatives in the supplied water once decreases, then the activity thereof also decreases, and urea and urea derivatives may leak into the treated water because the activity cannot follow the subsequent rapid increase in the concentration of urea and urea derivatives in the supplied water.

Given the above, in order to follow the concentration variation of urea and urea derivatives in the supplied water to maintain the urea concentration in the biologically treated water at a low level, it may be considered to constantly add ammoniacal nitrogen source to maintain the activity of the nitrifying bacteria group. However, even though the removability for ammoniacal nitrogen may be maintained, the removability for urea and urea derivatives cannot necessarily be maintained.

According to the above invention (Invention 2), in order to immediately follow the variation of the concentration of urea and urea derivatives in the raw water when the ammoniacal nitrogen sources are added to the raw water in the above invention (Invention 1), the pH is adjusted within a range of 5 to 6.5 thereby resulting in that the nitrifying bacteria group, which has an optimum value in the neutral region, deteriorates both the ammonia oxidizing activity and the urea-decomposing activity compared to those at optimum pHs, but the deterioration of the urea-decomposing activity is less than that of the ammonia oxidizing activity. In addition, ammonia in ionic state increases, and the amount of ammonia incorporated into the nitrifying bacteria group decreases. Due to the above, urea consumed by the nitrifying bacteria group increases, so that the activity of the nitrifying bacteria group can be maintained even if the urea concentration significantly varies, and urea can efficiently be decomposed/removed.

In the above invention (Invention 1, 2), it is preferred that the ammoniacal nitrogen sources are such that a NH₄⁺—N/urea is 100 or less relative to the concentration of the urea (Invention 3). According to the above invention (Invention 3), the concentration of ammonia is made to be 100 times or less relative to the concentration of urea, and a function for preferentially decomposing/removing urea can thereby be maintained.

In the above invention (Invention 1-3), it is preferred that the ammoniacal nitrogen sources are represented by ammonium salt (Invention 4). According to the above invention (Invention 4), ammonium salt such as ammonium chloride, which is oxidized by ammonia oxidizing bacteria to be nitrite ion (NO₂⁻), is preferable for activating the nitrifying bacteria group and also preferable for maintaining the concentration of urea at a low level because the addition/control thereof is easy.

In the above invention (Invention 1-4), it is preferred that the biological treatment is performed by a biological treatment means that has a biologically supporting carrier (Invention 5). Moreover, in the above invention (Invention 5), it is preferred that the biological treatment is performed by a biological treatment means that has a fixed bed of the biologically supporting carrier (Invention 6). Furthermore, in the above invention (Invention 5, 6), it is preferred that the biologically supporting carrier is an activated charcoal (Invention 7). According to the above invention (Invention 5-7), the biological treatment means employs a biological membrane method using the biologically supporting carrier, so that bacteria bodies can be suppressed from flowing out from the biological treatment means compared to the case of a fluidized bed, and an effective treatment is achieved in which the effect can be maintained for a long period of time.

It is preferred that the above invention (Invention 1-7) further comprises performing a reduction treatment after the biological treatment (Invention 8). According to the above invention (Invention 8), advantageous effects can be obtained as follows. Chlorine-based oxidizing agent (such as hypochlorous acid) may often exist in raw water for a biological treatment, but such an agent may react with ammoniacal nitrogen source to form a combined chlorine compound. The combined chlorine compound has lower oxidizing power compared to free chlorine, but may possibly lead to oxidation degradation of treating tools in the subsequent treatment. In this regard, performing the reduction treatment allows such combined chlorine compounds to be harmless.

Second, the present invention provides an ultrapure water production method characterized by comprising: obtaining treated water through the water treatment method according to the above invention (Invention 1-8); and treating the treated water by a primary pure water apparatus and a secondary pure water apparatus to produce ultrapure water (Invention 9).

According to the above invention (Invention 9), urea in water to be treated (raw water) is sufficiently decomposed/removed in the biological treatment (water treatment) before being subjected to the primary pure water apparatus and the secondary pure water apparatus, and thereby highly pure ultrapure water can efficiently be produced.

### Advantageous Effect of the Invention

According to the water treatment method of the present invention, it is possible to highly decompose TOC, particularly urea, in the raw water.

### BRIEF DESCRIPTION OF DRAWINGS

FIG. 1 is a system diagram illustrating a water treatment method according to a first embodiment of the present invention.

FIG. 2 is a system diagram illustrating a water treatment method according to a second embodiment of the present invention.

FIG. 3 is a system diagram illustrating a water treatment method according to a third embodiment of the present invention.

FIG. 4 is a system diagram illustrating a water treatment method according to a fourth embodiment of the present invention.

FIG. 5 is a system diagram illustrating a water treatment method according to a fifth embodiment of the present invention.

FIG. 6 is a schematic diagram illustrating action and advantageous effects in the fifth embodiment.

FIG. 7 is a system diagram illustrating a water treatment method according to a sixth embodiment of the present invention.

FIG. 8 is a system diagram illustrating an ultrapure water production method according to one embodiment of the present invention.

FIG. 9 is a graph illustrating urea removal effect in Example 1 and Example 2.

FIG. 10 is a graph illustrating urea removal effect in Example 5 and Example 6.

### Embodiments For Carrying Out the Invention

### First Embodiment

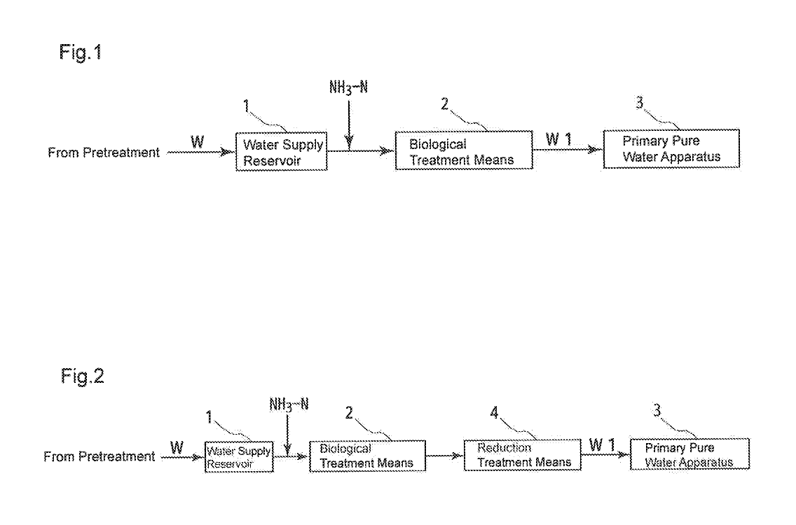

Embodiments according to the present invention will hereinafter be described with reference to accompanying drawings. FIG. 1 is a schematic diagram illustrating a water treatment method according to a first embodiment of the present invention.

In FIG. 1, reference numeral 1 denotes a water supply reservoir that reserves raw water W supplied from a pretreatment apparatus, and the raw water W supplied from this water supply reservoir 1 is biologically treated by a biological treatment means 2 before being supplied as treated water W1 to a primary pure water apparatus 3. In addition, an ammoniacal nitrogen source (NH₃—N) is added thereto before the biological treatment means 2.

In such a treatment flow, the raw water W as an object to be treated may be groundwater, river water, city water, other industrial water, recovered water from a semiconductor manufacturing process, or other appropriate water. Such water may also be used after being clarified. A treatment for such clarification is preferably performed by a pretreatment system in a production process for ultrapure water or a similar process thereto. Specifically, a process, such as aggregation, pressurized floatation or filtration, or any combination thereof, may be preferable.

It is preferred that the urea concentration in raw water (water to be treated) is within a range of about 5 to 200 μg/L and particularly within a range of about 5 to 100 μg/L.

The biological treatment means 2 as used in the present embodiment is a means that performs a treatment for decomposing and/or stabilizing pollution substances in wastewater, such as sewage water, by using biological action, and the biological treatment means 2 may be either of an aerobic treatment and an anaerobic treatment. In general, organic substances are subjected to a biological treatment to be decomposed by processes, such as oxygen respiration process, nitric acid respiration process and fermentation process, thus being gasified, or to be removed as sludge after being involved into microorganism. In addition, a removal treatment is also possible for nitrogen (nitrification denitrification method) and/or phosphorus (biological phosphorus removal method). A means for performing such biological treatments is referred commonly to as a biological reaction tank. Although not particularly limited, it is preferred that such a biological treatment means 2 has a fixed bed of biologically supporting carriers. In particular, a downward flowing type fixed bed is preferable because of less flowing out bacteria bodies.

If the biological treatment means 2 is provided as a fixed bed, it is preferred to wash the fixed bed as needed. This prevents problems from occurring, such as obstruction at the fixed bed, formation of mud balls and deterioration in decomposing/removing efficiency for urea due to growth of living organisms (bacteria bodies). This washing method is preferred to be achieved such that, but not limited to, reverse-washing is performed, i.e. washing water is caused to flow for fluidizing the carriers in the reverse direction to the passing direction of the raw water, thereby to perform discharging deposited materials outward from the system, crushing mud balls, detaching a part of living organisms and other necessary actions.

Further, types of carriers of the fixed bed are not particularly limited, and activated charcoal, anthracite, sand, zeolite, ion-exchange resin, molded plastic product or other appropriate materials may be used, but it is preferred to use carriers that less consume oxidizing agent and/or disinfecting agent in order to execute the biological treatment in the presence of oxidizing agent and/or disinfecting agent. If, however, oxidizing agent and/or disinfecting agent of high concentration may possibly flow into the biological treatment means, then it is preferred that carriers such as activated charcoal capable of decomposing the oxidizing agent and/or disinfecting agent are used. Using such an activated charcoal or other appropriate carriers thus prevents bacteria bodies from being deactivated or distinguished even if the concentration of the oxidizing agent and/or disinfecting agent is high.

It is preferred that the water passing speed to the biological treatment means 2 is about SV 5 to 50 hr⁻¹. It is also preferred that water temperature of water to be supplied to the biological treatment means 2 is room temperature, e.g. 10° C. to 35° C., and the pH is neutral, e.g. 4 to 8. Therefore, a heat exchanger and/or an adding means for pH adjusting agent may preferably be provided as a preceding stage for the biological treatment means 2, if required.

Before being introduced into the biological treatment means 2, the raw water W is added thereto with ammoniacal nitrogen source. Preferable examples of this ammoniacal nitrogen source to be used include, such as, but not limited to, ammonium salt (inorganic compound) and ammonia water (ammonium hydroxide) as well as an organic substance from which ammonium ion or free ammonia can be generated due to biodegradation of protein and the like. Among them, inorganic ammonium salt such as ammonium chloride is preferable.

The adding amount of the ammoniacal nitrogen source as described above may be within a range of 0.1 to 5 mg/L (NH₄⁺ equivalent). Specifically, the ammoniacal nitrogen source may be added so that the concentration of ammonium ion in the raw water W is within the above range. If the ammonium ion concentration in the raw water W is less than 0.1 mg/L (NH₄⁺ equivalent), then the activity of nitrifying bacteria group is difficult to be maintained, while on the other hand, even if the ammonium ion concentration in the raw water W exceeds 5 mg/L (NH₄⁺ equivalent), not only further activity of nitrifying bacteria group cannot be obtained, but also the leak amount from the biological treatment means 2 unduly increases, thus both cases being undesirable.

By adding the ammoniacal nitrogen source so that the concentration of ammonium ion in the raw water W is within the above range, the urea concentration in the treated water W1 in the biological treatment means 2 may be maintained as being 5 μg/L or less and particularly 2 μg/L or less after the passage of about 10 days to 30 days.

The present inventors have discovered that the ammoniacal nitrogen source is added to the raw water W in the above manner thereby to provide a drastic advantageous effect that urea and urea derivatives as the TOC can stably be decomposed. This is supposed to be for reasons as follows. That is, the concentration of urea and urea derivatives is known as varying with seasons in city water and industrial water, and if the concentration of urea and urea derivatives in the raw water W once decreases, then the activity of nitrifying bacteria group deteriorates, and urea and urea derivatives leak into the treated water W1 because the activity of nitrifying bacteria group cannot follow the subsequent rapid increase in the concentration of urea and urea derivatives thus being insufficient to decompose them. In this respect, the ammoniacal nitrogen source is added to maintain the activity of nitrifying bacteria group thereby following the concentration change of urea and urea derivatives in the raw water W, and the biological treatment means 2 can thus maintain at low level the urea concentration in the treated water W1.

The ammoniacal nitrogen source is not necessary to be constantly added, and various methods may be used, such as a method where the addition is performed only during the start-up after the biological carriers are exchanged and a method where addition and no-addition are repeated with a certain period. Avoiding the ammoniacal nitrogen source to be constantly added provides an additional advantageous effect that the cost for adding the ammoniacal nitrogen source can be reduced.

Note that the nitrifying bacteria deteriorate their activity if a condition (empty-aeration condition) continues where no feed (such as ammoniacal nitrogen source, urea and urea derivatives) exists in the presence of dissolved oxygen. Specific approaches for avoiding this activity deterioration include: (1) a method of constantly or intermittently adding ammoniacal nitrogen source (the method according to the present embodiment); (2) a method of controlling the addition of ammoniacal nitrogen source in response to the concentration of such as ammoniacal nitrogen and urea in the supplied water to the biological treatment or in the treated water; and (3) a method of controlling the dissolved oxygen concentration like the above (2) (removal of dissolved oxygen such as by addition of deoxygenating agent, addition of reducing agent, de-aeration treatment and nitrogen gas aeration, etc). In view of simplicity and cost, the method according to the present embodiment (the method according to the above (1)) appears to be more preferable.

Note also that the raw water W may further be added thereto with oxidizing agent and/or disinfecting agent, if necessary. Types of the oxidizing agent and/or disinfecting agent to be added are not particularly limited, and ones may preferably be used which can prioritize bacteria species that efficiently decompose urea. Specific examples to preferably be used include chlorine-based oxidizing agents, such as sodium hypochlorite and chlorine dioxide, and combined chlorine agents (stabilized chlorine agents), such as monochloramine and dichloramine.

According to the water treatment method in the first embodiment of the present invention as described above, the biological treatment is performed after the ammoniacal nitrogen source is added to raw water that contains organic substances, and nitrifying bacteria group can thus grow and enhance their activity thereby decomposing and removing urea. The water treatment according to such a water treatment method may be performed before the primary pure water apparatus and secondary pure water apparatus thereby to allow for efficiently producing highly-pure ultrapure water with low TOC concentration.

### Second Embodiment

A water treatment method according to a second embodiment of the present invention will then be described with reference to FIG. 2. The water treatment method according to the second embodiment has a similar configuration to that of the above-described first embodiment except for having a reduction treatment means 4 after the biological treatment means 2 and before the primary pure water apparatus 3.

Employing such a configuration provides advantages as follows. When chlorine-based oxidizing agent (such as hypochlorous acid) is used in the above-described first embodiment and excessive chlorine exists, they react with the ammoniacal nitrogen source to be a combined chlorine compound. This combined chlorine compound has lower oxidizing power compared to free chlorine, but may possibly lead to problems in the subsequent primary pure water apparatus 3 and other processes, such as oxidation degradation of constitutional elements therein. In this regard, performing the reduction treatment allows such combined chlorine compounds to be harmless.

It is known that, if activated charcoal is used as the fixed bed of biologically supporting carriers in the biological treatment means 2, then the activated charcoal can perform reduction treatment for chlorine-based oxidizing agents due to catalytic reaction. However, the activated charcoal cannot rapidly reduce the combined chlorine compounds, which are thus easy to be leaked and may possibly remain to affect the subsequent primary pure water apparatus 3. Therefore, it is preferred that the reduction treatment means 4 is provided even if activated charcoal is used.

The above reduction treatment means 4 may for example be achieved by adding: gases such as hydrogen gas; lower oxides such as sulfur dioxide; lower oxygen acid salts such as thiosulfate, sulfite, bisulfite and nitrite; lower valent metal salts such as iron (II) salt; organic acids such as formic acid, oxalic acid and L-ascorbic acid or salts thereof; and other reducing agents such as hydrazine, aldehydes and sugars. Among them, nitrite, sulfite, iron (II) salt, sulfur dioxide or bisulfite, or oxalic acid, L-ascorbic acid or salts thereof, may be preferably used. In addition, an activated charcoal tower may be provided as the reduction treatment means 4, in which reduction is further performed by activated charcoal.

If a reducing agent is added, it is preferred that the adding amount of the reducing agent is appropriately adjusted depending on the oxidizing agent concentration. For example, sodium sulfite as the reducing agent to reduce residual chlorine may be added so that sulfite ion (SO₃²⁻) and hypochlorite ion (ClO⁻) are equimolar, and 1.2 times to 3.0 times of the amount may be added in consideration of safety factor. It is more preferred that the oxidizing agent concentration in the treated water, which may vary, is monitored and the reducing agent adding amount is controlled depending on the monitored oxidizing agent concentration. Alternatively, a simplified method may be used in which the oxidizing agent concentration is measured at fixed intervals and the adding amount is appropriately set in accordance with the measured concentration. Note that the detection means for the oxidizing agent concentration may be represented by oxidation-reduction potential (ORP) while that for the residual chlorine may be represented by residual chlorine meter (such as using polarographic method).

### Third Embodiment

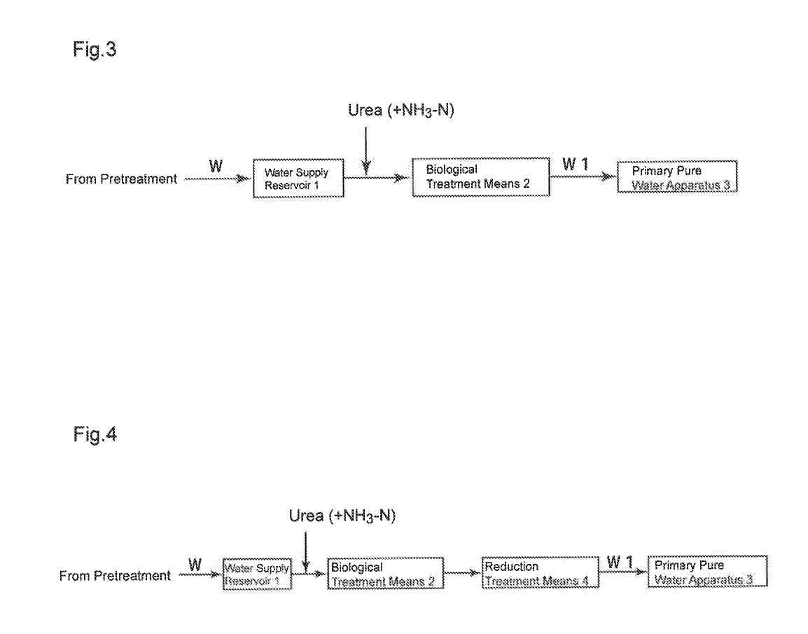

A water treatment method according to a third embodiment of the present invention will then be described with reference to FIG. 3. FIG. 3 is a schematic diagram illustrating the water treatment method according to the third embodiment of the present invention.

In FIG. 3, reference numeral 1 denotes a water supply reservoir that reserves raw water W supplied from a pretreatment apparatus, and the raw water W supplied from this water supply reservoir 1 is biologically treated by a biological treatment means 2 before being supplied as treated water W1 to a primary pure water apparatus 3. In addition, urea or one or more urea derivatives are added thereto before the biological treatment means 2.

In such a treatment flow, the raw water W as an object to be treated may be groundwater, river water, city water, other industrial water, recovered water from a semiconductor manufacturing process, or other appropriate water. Such water may also be used after being clarified. A treatment for such clarification is preferably performed by a pretreatment system in a production process for ultrapure water or a similar process thereto. Specifically, a process, such as aggregation, pressurized floatation or filtration, or any combination thereof, may be preferable.

It is preferred that the urea concentration in raw water (water to be treated) is within a range of about 5 to 200 μg/L and particularly within a range of about 5 to 100 μg/L.

The biological treatment means 2 as used in the present embodiment is a means that performs a treatment for decomposing and/or stabilizing pollution substances in wastewater, such as sewage water, by using biological action, and the biological treatment means 2 may be either of an aerobic treatment and an anaerobic treatment. In general, organic substances are subjected to a biological treatment to be decomposed by processes, such as oxygen respiration process, nitric acid respiration process and fermentation process, thus being gasified, or to be removed as sludge after being involved into microorganism. In addition, a removal treatment is also possible for nitrogen (nitrification denitrification method) and/or phosphorus (biological phosphorus removal method). A means for performing such biological treatments is referred commonly to as a biological reaction tank. Although not particularly limited, it is preferred that such a biological treatment means 2 has a fixed bed of biologically supporting carriers. In particular, a downward flowing type fixed bed is preferable because of less flowing out bacteria bodies.

If the biological treatment means 2 is provided as a fixed bed, it is preferred to wash the fixed bed as needed. This prevents problems from occurring, such as obstruction at the fixed bed, formation of mud balls and deterioration in decomposing/removing efficiency for urea due to growth of living organisms (bacteria bodies). This washing method is preferred to be achieved such that, but not limited to, reverse-washing is performed, i.e. washing water is caused to flow for fluidizing the carriers in the reverse direction to the passing direction of the raw water, thereby to perform discharging deposited materials outward from the system, crushing mud balls, detaching a part of living organisms and other necessary actions.

Further, types of carriers of the fixed bed are not particularly limited, and activated charcoal, anthracite, sand, zeolite, ion-exchange resin, molded plastic product or other appropriate materials may be used, but it is preferred to use carriers that less consume oxidizing agent and/or disinfecting agent in order to execute the biological treatment in the presence of oxidizing agent and/or disinfecting agent. If, however, oxidizing agent and/or disinfecting agent of high concentration may possibly flow into the biological treatment means, then it is preferred that carriers such as activated charcoal capable of decomposing the oxidizing agent and/or disinfecting agent are used. Using such an activated charcoal or other appropriate carriers thus prevents bacteria bodies from being deactivated or distinguished even if the concentration of the oxidizing agent and/or disinfecting agent is high.

It is preferred that the water passing speed to the biological treatment means 2 is about SV 5 to 50 hr⁻¹. It is also preferred that water temperature of water to be supplied to the biological treatment means 2 is room temperature, e.g. 10° C. to 35° C., and the pH is neutral, e.g. 4 to 8. Therefore, a heat exchanger and/or an adding means for pH adjusting agent may preferably be provided as a preceding stage for the biological treatment means 2, if required.

In the present embodiment, before being introduced into the biological treatment means 2, the raw water W is added thereto with urea or urea derivatives. Urea or urea derivatives are added to the raw water W to thereby allow for maintaining minimum urea-decomposing bacteria (presumed as a kind of nitrifying bacteria) in the biological treatment means 2 even if a certain amount of time has passed after the urea concentration in the raw water W decreased. Therefore, the urea removability can be maintained even in the case where the urea concentration in the raw water W increases after remaining at low level over a long period of time.

Among urea or urea derivatives to be added to the biological treatment means 2, urea is preferred to be used because urea is the same component as an object expected to be removed, thereby being effective in maintaining bacteria bodies suitable for urea removal. However, urea has small molecular weight and low ionicity, and therefore, if urea cannot completely be removed by the biological treatment means 2, then the remaining urea may also be difficult to be removed by reverse osmosis membrane treatment and ion exchange treatment in the subsequent primary pure water apparatus 3, and there is a risk that the water quality of obtained ultrapure water may be affected therefrom. Accordingly, it is preferred that urea is added with minimum required amount.

Further, if urea derivatives are added, examples thereof to be used include methylurea, butylurea, phenylurea, naphthylurea, dimethylurea, semicarbazide, allantoin, citrulline, and proteins such as albumin, etc. Urea derivatives having large molecular weight to some extent and ionicity in contrast to the previously-described urea can eliminate the risk for the water quality of ultrapure water because they are expected to partially or completely be removed by the reverse osmosis membrane treatment and the ion exchange treatment in the subsequent primary pure water apparatus 3 even if not having been completely removed by the biological treatment means 2. It should be appreciated, however, that urea derivatives may possibly not necessarily be able to sufficiently maintain most suitable bacteria bodies for urea removal because the urea derivatives are not the same as urea that is expected to be removed.

The adding amount of urea or urea derivatives as described above is preferred to be a concentration of ½ to 1/10 of the expected maximum urea concentration in consideration of the fluctuating range of the urea concentration in the raw water W. It is preferred that the specific concentration is within a range of about 1 to 20 μg/L. If the added concentration of urea is less than 1 μg/L, then the minimum urea-decomposing bacteria required for removing urea are difficult to be maintained, while on the other hand, if the added concentration exceeds 20 μg/L, then the biological treatment means 2 cannot completely remove urea and the leaked urea into the subsequent stage causes the TOC of ultrapure water to rise, thus both cases not being preferable.

Moreover, in the present embodiment, ammoniacal nitrogen source is further added in addition to the previously-described urea or urea derivatives to thereby complementarily act for urea or urea derivatives. The addition of ammoniacal nitrogen source thus enhances the growth and the activity of urea-decomposing bacteria (presumed as a kind of nitrifying bacteria) while suppressing the adding amount of urea or urea derivatives, and higher advantageous effects can be obtained for load fluctuation.

In addition, even during periods where the urea concentration in the raw water W is reduced, adding ammoniacal nitrogen source allows the activity of urea-decomposing bacteria to be maintained, and adding ammoniacal nitrogen source in combination with a small amount of urea or urea derivatives allows for maintaining the minimum bacteria group suitable for removal of urea or urea derivatives while achieving sufficient urea removability even in the case where the urea concentration in the raw water increases after remaining at low level over a long period of time.

Preferable examples of the above-described ammoniacal nitrogen source to be used include, such as, but not limited to, ammonium salt (inorganic compound) and ammonia water (ammonium hydroxide) as well as an organic substance from which ammonium ion or free ammonia can be generated due to biodegradation of protein and the like. Among them, inorganic ammonium salt such as ammonium chloride is preferable.

The adding amount of the ammoniacal nitrogen source as described above may be within a range of 0.1 to 5 mg/L (NH₄⁺ equivalent). Specifically, the ammoniacal nitrogen source may be added so that the concentration of ammonium ion in the raw water W is within the above range. If the ammonium ion concentration in the raw water W is less than 0.1 mg/L (NH₄⁺ equivalent), then the activity of nitrifying bacteria group is difficult to be maintained, while on the other hand, even if the ammonium ion concentration in the raw water W exceeds 5 mg/L (NH₄⁺ equivalent), not only further activity of nitrifying bacteria group cannot be obtained, but also the leak amount from the biological treatment means 2 unduly increases, thus both cases being undesirable.

By adding the ammoniacal nitrogen source in combination with urea or urea derivatives so that the concentration of ammonium ion in the raw water W is within the above range, the urea concentration in the treated water W1 in the biological treatment means 2 may be maintained as being 5 μg/L or less and particularly 2 μg/L or less after the passage of about 10 days to 30 days.

The reason that urea or urea derivatives and if necessary the ammoniacal nitrogen source are added to the raw water W in the above manner thereby allowing urea and urea derivatives as the TOC to stably be decomposed is supposed as follows. That is, the concentration of urea and urea derivatives is known as varying with seasons in city water and industrial water, and if the concentration of urea and urea derivatives in the raw water W once decreases, then the activity of nitrifying bacteria group deteriorates, and urea and urea derivatives leak into the treated water W1 because the activity of nitrifying bacteria group cannot follow the subsequent rapid increase in the concentration of urea and urea derivatives thus being insufficient to decompose them. In this respect, urea or urea derivatives and if necessary the ammoniacal nitrogen source are added to the raw water W to maintain the activity of nitrifying bacteria group thereby following the concentration change of urea and urea derivatives in the raw water W, and the biological treatment means 2 can thus maintain at low level the urea concentration in the treated water W1.

As a method for adding the above urea or urea derivatives and the ammoniacal nitrogen source as an arbitrary additive, any of a method of constantly adding a fixed amount and a method of intermittently adding may be preferably used. Avoiding them to be constantly added provides an additional advantageous effect that the cost for adding the urea or urea derivatives and the ammoniacal nitrogen source as an arbitrary additive can be reduced.

Note that the nitrifying bacteria deteriorate their activity if a condition (empty-aeration condition) continues where no feed (such as ammoniacal nitrogen source, urea and urea derivatives) exists in the presence of dissolved oxygen. Specific approaches for avoiding this activity deterioration include: (1) a method of constantly or intermittently adding ammoniacal nitrogen source (the method according to the present embodiment); (2) a method of controlling the addition of ammoniacal nitrogen source in response to the concentration of such as ammoniacal nitrogen and urea in the supplied water to the biological treatment or in the treated water; and (3) a method of controlling the dissolved oxygen concentration like the above (2) (removal of dissolved oxygen such as by addition of deoxygenating agent, addition of reducing agent, de-aeration treatment and nitrogen gas aeration, etc). In view of simplicity and cost, the method according to the present embodiment (the method according to the above (1)) appears to be more preferable.

Note also that the raw water W may further be added thereto with oxidizing agent and/or disinfecting agent, if necessary. Types of the oxidizing agent and/or disinfecting agent to be added are not particularly limited, and ones may preferably be used which can prioritize bacteria species that efficiently decompose urea. Specific examples to preferably be used include chlorine-based oxidizing agents, such as sodium hypochlorite and chlorine dioxide, and combined chlorine agents (stabilized chlorine agents), such as monochloramine and dichloramine.

According to the water treatment method in the present embodiment, the biological treatment is performed after urea or urea derivatives are added to raw water that contains organic substances, so that the minimum urea-decomposing bacteria (presumed as a kind of nitrifying bacteria) can be obtained even in the case where the concentration of urea in the raw water is reduced, and the urea removability can also be maintained even if the urea concentration in the raw water increases after remaining at low level over a long period of time.

### Fourth Embodiment

A water treatment method according to a fourth embodiment of the present invention will then be described with reference to FIG. 4. The water treatment method according to the fourth embodiment has a similar configuration to that of the above-described third embodiment except for having a reduction treatment means 4 after the biological treatment means 2 and before the primary pure water apparatus 3.

Employing such a configuration provides advantages as follows. When chlorine-based oxidizing agent (such as hypochlorous acid) is used in the above-described third embodiment and excessive chlorine exists, they react with the ammoniacal nitrogen source to be a combined chlorine compound. This combined chlorine compound has lower oxidizing power compared to free chlorine, but may possibly lead to problems in the subsequent primary pure water apparatus 3 and other processes, such as oxidation degradation of constitutional elements therein. In this regard, performing the reduction treatment allows such combined chlorine compounds to be harmless.

It is known that, if activated charcoal is used as the fixed bed of biologically supporting carriers in the biological treatment means 2, then the activated charcoal can perform reduction treatment for chlorine-based oxidizing agents due to catalytic reaction. However, the activated charcoal cannot rapidly reduce the combined chlorine compounds, which are thus easy to be leaked and may possibly remain to affect the subsequent primary pure water apparatus 3. Therefore, it is preferred that the reduction treatment means 4 is provided even if activated charcoal is used.

The above reduction treatment means 4 may for example be achieved by adding: gases such as hydrogen gas; lower oxides such as sulfur dioxide; lower oxygen acid salts such as thiosulfate, sulfite, bisulfite and nitrite; lower valent metal salts such as iron (II) salt; organic acids such as formic acid, oxalic acid and L-ascorbic acid or salts thereof; and other reducing agents such as hydrazine, aldehydes and sugars. Among them, nitrite, sulfite, iron (II) salt, sulfur dioxide or bisulfate, or oxalic acid, L-ascorbic acid or salts thereof, may be preferably used. In addition, an activated charcoal tower may be provided as the reduction treatment means 4, in which reduction is further performed by activated charcoal.

If a reducing agent is added, it is preferred that the adding amount of the reducing agent is appropriately adjusted depending on the oxidizing agent concentration. For example, sodium sulfite as the reducing agent to reduce residual chlorine may be added so that sulfite ion (SO₃²⁻) and hypochlorite ion (ClO⁻) are equimolar, and 1.2 times to 3.0 times of the amount may be added in consideration of safety factor. It is more preferred that the oxidizing agent concentration in the treated water, which may vary, is monitored and the reducing agent adding amount is controlled depending on the monitored oxidizing agent concentration. Alternatively, a simplified method may be used in which the oxidizing agent concentration is measured at fixed intervals and the adding amount is appropriately set in accordance with the measured concentration. Note that the detection means for the oxidizing agent concentration may be represented by oxidation-reduction potential (ORP) while that for the residual chlorine may be represented by residual chlorine meter (such as using polarographic method).

### Fifth Embodiment

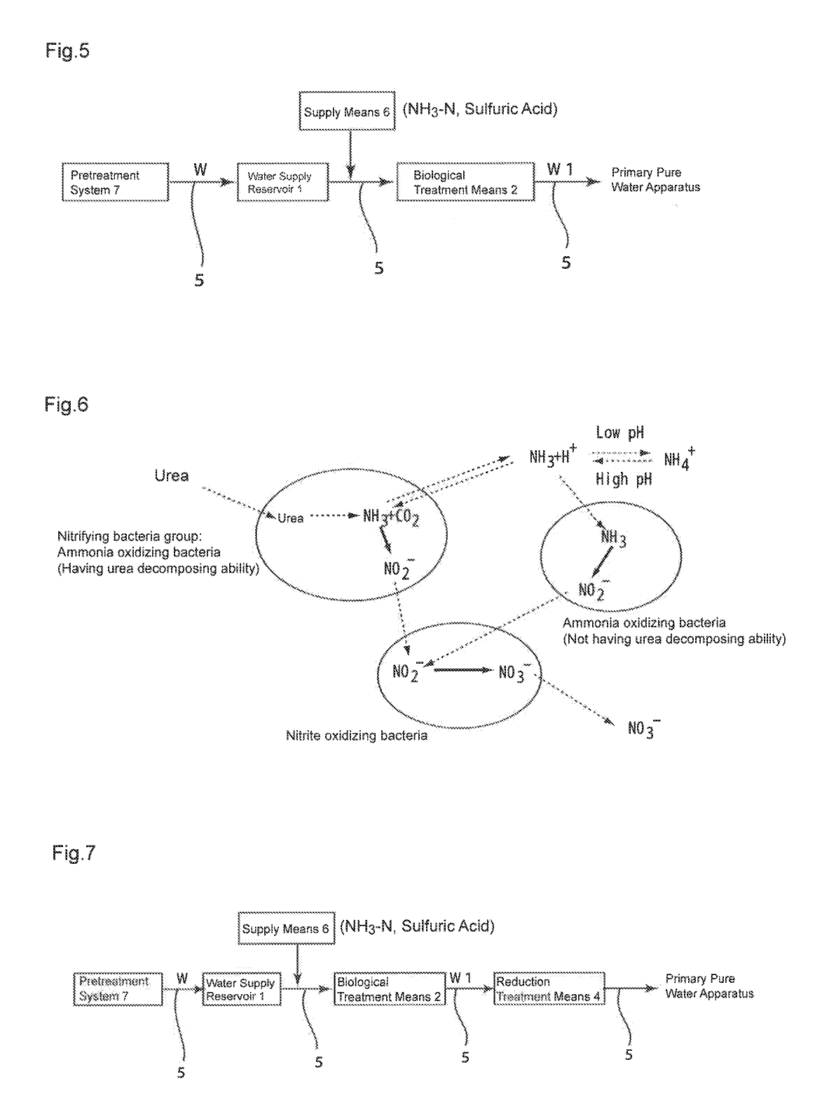

A water treatment method according to a fifth embodiment of the present invention will then be described with reference to appropriate drawings. FIG. 5 is a schematic diagram illustrating the water treatment method according to the fifth embodiment of the present invention.

In FIG. 5, reference numeral 7 denotes a pretreatment system for raw water W supplied from a raw water reservoir not shown, and the raw water W treated by this pretreatment system 7 is once reserved in a water supply reservoir 1. In turn, this water supply reservoir 1 is connected in series with a biological treatment means 2, and the raw water W treated by this biological treatment means 2 can be supplied as treated water W1 to a primary pure water apparatus. A pH sensor not shown and a supply means 6 are provided as a preceding stage to the biological treatment means 2, and this supply means 6 can add an ammoniacal nitrogen source (NH₃—N) and sulfuric acid as a pH adjusting agent. Note that reference numeral 5 denotes transferring/supplying pipe conduits.

In the biological treatment apparatus having a configuration as described above, the raw water W as an object to be treated may be groundwater, river water, city water, other industrial water, recovered water from a semiconductor manufacturing process, or other appropriate water. It is preferred that the urea concentration in raw water (water to be treated) is within a range of about 5 to 200 μg/L and particularly within a range of about 5 to 100 μg/L.

Further, the pretreatment system 7 is preferred to be a common pretreatment system in a production process for ultrapure water or a similar treatment system thereto. Specifically, a treatment system comprised of aggregation, pressurized floatation, filtration, etc. may be used.

The biological treatment means 2 is a means that performs a treatment for decomposing and/or stabilizing pollution substances in wastewater, such as sewage water, by using biological action, and the biological treatment means 2 may be either of an aerobic treatment and an anaerobic treatment. In general, organic substances are subjected to a biological treatment to be decomposed by processes, such as oxygen respiration process, nitric acid respiration process and fermentation process, thus being gasified, or to be removed as sludge after being involved into microorganism. In addition, a removal treatment is also possible for nitrogen (nitrification denitrification method) and/or phosphorus (biological phosphorus removal method). A means for performing such biological treatments is referred commonly to as a biological reaction tank. Although not particularly limited, it is preferred that such a biological treatment means 2 has a fixed bed of biologically supporting carriers. In particular, a downward flowing type fixed bed is preferable because of less flowing out bacteria bodies.

If the biological treatment means 2 is provided as a fixed bed, it is preferred to wash the fixed bed as needed. This prevents problems from occurring, such as obstruction at the fixed bed, formation of mud balls and deterioration in decomposing/removing efficiency for urea due to growth of living organisms (bacteria bodies). This washing method is preferred to be achieved such that, but not limited to, reverse-washing is performed, i.e. washing water is caused to flow for fluidizing the carriers in the reverse direction to the passing direction of the raw water, thereby to perform discharging deposited materials outward from the system, crushing mud balls, detaching a part of living organisms and other necessary actions.

Further, types of carriers of the fixed bed are not particularly limited, and activated charcoal, anthracite, sand, zeolite, ion-exchange resin, molded plastic product or other appropriate materials may be used, but it is preferred to use carriers that less consume oxidizing agent in order to execute the biological treatment in the presence of oxidizing agent. If, however, oxidizing agent of high concentration may possibly flow into the biological treatment means, then it is preferred that carriers such as activated charcoal capable of decomposing the oxidizing agent are used. Using such an activated charcoal or other appropriate carriers thus prevents bacteria bodies from being deactivated or distinguished even if the concentration of the oxidizing agent is high.

It is preferred that the water passing speed to the biological treatment means 2 is about SV 5 to 50 hr⁻¹. It is also preferred that water temperature of water to be supplied to the biological treatment means 2 is room temperature, e.g. 10° C. to 35° C. Therefore, a heat exchanger may preferably be provided as a preceding stage for the biological treatment means 2, if required.

Preferable available examples of the ammoniacal nitrogen source supplied from the supply means 6 to the biological treatment means 2 include, such as, but not limited to, ammonium salt (inorganic compound) and ammonia water (ammonium hydroxide) as well as an organic substance from which ammonium ion or free ammonia can be generated due to biodegradation of protein and the like. Among them, inorganic ammonium salt such as ammonium chloride is preferable.

Descriptions will then be directed to the water treatment method using the apparatus configured as described above and additives etc.

At first, the pretreatment system 7 is supplied thereto with the raw water W to remove turbid components in the raw water W thereby suppressing the decomposing/removing efficiency of organic substances from deteriorating in the subsequent biological treatment means 2 due to the turbid components and also suppressing the pressure loss in the biological treatment means 2 from increasing.

If necessary, a heat exchanger not shown is used for performing temperature adjustment to heat the pretreated raw water W when the water temperature thereof is low or cool the pretreated raw water W when the water temperature is high so that the water temperature becomes a predetermined water temperature. This is because the reaction rate increases to improve the decomposing efficiency as the water temperature of the raw water W increases. If, however, the water temperature is high, then components, such as a processing tank in the biological treatment means 2 and pipe works of the transferring/supplying pipe conduits 5, are required to have heat resistance properties thereby leading to increase in facilities' cost. In addition, lower water temperature of the raw water W results in increase in heating cost. Specifically, if the water temperature is 40° C. or lower, then the biological reaction is such that the biological activity and the removal rate are basically enhanced as the water temperature increases. If, however, the water temperature exceeds 40° C., then the biological activity and the removal efficiency may conversely tend to decrease. For the reasons above, the treatment water temperature is preferred to be within a range of 20° C. to 40° C. Therefore, nothing is required to be done if the initial temperature of the raw water W is within the above range.

In this way, the raw water W adjusted in temperature as needed is supplied to the biological treatment means 2, and organic substances, particularly persistent organic substances such as urea, are decomposed/removed. During this treatment, the supply means 6 adds ammoniacal nitrogen source while adding sulfuric acid to adjust the pH of the raw water W within a range of 5 to 6.5.

The adding amount of the ammoniacal nitrogen source as described above may be within a range of 0.1 to 5 mg/L (NH₄⁺ equivalent). Specifically, the ammoniacal nitrogen source is added so that the concentration of ammonium ion in the raw water W is within the above range. If the ammonium ion concentration in the raw water W is less than 0.1 mg/L (NH₄⁺ equivalent), then the activity of nitrifying bacteria group is difficult to be maintained, while on the other hand, even if the ammonium ion concentration in the raw water W exceeds 5 mg/L (NH₄⁺ equivalent), not only further activity of nitrifying bacteria group cannot be obtained, but also the leak amount from the biological treatment means 2 unduly increases, thus both cases being undesirable.

By adding the ammoniacal nitrogen source so that the concentration of ammonium ion in the raw water W is within the above range, the urea concentration in the treated water W1 in the biological treatment means 2 can be 5 μg/L or less and particularly 2 μg/L or less after the passage of about 10 days to 30 days.

In this way, the ammoniacal nitrogen source is added to the raw water W thereby allowing urea and urea derivatives as the TOC to stably be decomposed. This is supposed to be for reasons as follows. That is, the concentration of urea and urea derivatives is known as varying with seasons in city water and industrial water, and if the concentration of urea and urea derivatives in the raw water W once decreases, then the activity of nitrifying bacteria group that assimilates urea deteriorates, and urea and urea derivatives leak into the treated water W1 because the activity of nitrifying bacteria group cannot follow the subsequent rapid increase in the concentration of urea and urea derivatives thus being insufficient to decompose them. In this respect, the ammoniacal nitrogen source is added and the nitrifying bacteria group thus oxidizes the ammoniacal nitrogen source to generate nitrite ions (NO₂) thereby maintaining the activity. This allows the activity of the nitrifying bacteria group to follow the concentration change of urea and urea derivatives in the raw water W, and the biological treatment means 2 can thus maintain at low level the urea concentration in the treated water W1.

The ammoniacal nitrogen source is not necessary to be constantly added, and various methods may be used, such as a method where the addition is performed only during the start-up after the biological carriers are exchanged and a method where addition and no-addition are repeated with a certain period. Avoiding the ammoniacal nitrogen source to be constantly added provides an additional advantageous effect that the cost for adding the ammoniacal nitrogen source can be reduced.

Note that the nitrifying bacteria deteriorate their activity if a condition (empty-aeration condition) continues where no feed (such as ammoniacal nitrogen source, urea and urea derivatives) exists in the presence of dissolved oxygen. Specific approaches for avoiding this activity deterioration include: (1) a method of constantly or intermittently adding ammoniacal nitrogen source (the method according to the present embodiment); (2) a method of controlling the addition of ammoniacal nitrogen source in response to the concentration of such as ammoniacal nitrogen and urea in the supplied water to the biological treatment or in the treated water; and (3) a method of controlling the dissolved oxygen concentration like the above (2) (removal of dissolved oxygen such as by addition of deoxygenating agent, addition of reducing agent, de-aeration treatment and nitrogen gas aeration, etc). In view of simplicity and cost, the method according to the present embodiment (the method according to the above (1)) appears to be more preferable.

In addition, the reason that the pH of the raw water W during this treatment is adjusted within a range of 5 to 6.5 is as follows. That is, as shown in FIG. 6, the nitrifying bacteria group (ammonia oxidizing bacteria) that has urea-decomposing ability can assimilate both urea and ammonia, and substrates to be preferentially utilized change in accordance with environmental conditions. For example, in the case of high pH and/or high ammonia/urea ratio, ammonia is preferentially utilized, so that the urea-decomposing ability rather deteriorates. Accordingly, the pH of the raw water W is adjusted within a range of 5 to 6.5 thereby resulting in that the nitrifying bacteria group, which has an optimum value in the neutral region, deteriorates both the ammonia oxidizing activity and the urea-decomposing activity compared to those at optimum pHs, but the deterioration of the urea-decomposing activity is less than that of the ammonia oxidizing activity. In addition, ammonia in ionic state increases, and the amount of ammonia incorporated into the ammonia oxidizing bacteria decreases. Due to the above, urea decomposed by the nitrifying bacteria group increases. These actions allow for maintaining the activity of the nitrifying bacteria group even if the urea concentration significantly varies, and urea can efficiently be decomposed/removed. It should be appreciated that, with respect to the lower value of pH, if the pH of the raw water W is less than 5, then the activity of the nitrifying bacteria group is enhanced.

For similar reasons, it is preferred that the ammoniacal nitrogen source to be added from the supply means 6 is added so that the NH₄⁺—N/urea is 100 or less, and preferably 20 or less, relative to the concentration of the urea in the raw water W. If the concentration of the ammoniacal nitrogen source exceeds 100 times of the concentration of urea, then the nitrifying bacteria group as the urea-decomposing bacteria prioritizes decomposition of the ammoniacal nitrogen source, so that the decomposing ability for urea deteriorates thereby not capable of following significant increase in the urea concentration, and urea will be easy to leak into the treated water W1. Note that the lower limit of the adding amount of the ammoniacal nitrogen source is preferably such that the NH₄⁺—N/urea is 1 or more because the advantageous effect in activity maintaining of the nitrifying bacteria due to the addition is deteriorated if the adding amount is unduly small.

Note also that the raw water W may further be added thereto with oxidizing agent and/or disinfecting agent, if necessary. Types of the oxidizing agent and/or disinfecting agent to be added are not particularly limited, and ones may preferably be used which can prioritize bacteria species that efficiently decompose urea. Specific examples to preferably be used include chlorine-based oxidizing agents, such as sodium hypochlorite and chlorine dioxide, and combined chlorine agents (stabilized chlorine agents), such as monochloramine and dichloramine.

According to the water treatment method in the present embodiment, the ammoniacal nitrogen source is added to the raw water and oxidized by the nitrifying bacteria group (ammonia oxidizing bacteria) to generate nitrite ions (NO₂) thereby allowing for maintaining the activity of the nitrifying bacteria group and decomposing/removing urea. During this treatment, the pH is adjusted within a range of 5 to 6.5 to increase urea which is consumed by the nitrifying bacteria group, so that the activity of the nitrifying bacteria group can be maintained even if the urea concentration significantly varies, and urea can efficiently be decomposed/removed.

### Sixth Embodiment

A water treatment method according to a sixth embodiment of the present invention will then be described with reference to FIG. 7. The water treatment method according to the sixth embodiment has a similar configuration to that of the previously-described fifth embodiment except for having a reduction treatment means 4 after the biological treatment means 2 and before the primary pure water apparatus 3.

Employing such a configuration provides advantages as follows. When chlorine-based oxidizing agent (such as hypochlorous acid) is used in the previously-described fifth embodiment and excessive chlorine exists, they react with the ammoniacal nitrogen source to be a combined chlorine compound. This combined chlorine compound has lower oxidizing power compared to free chlorine, but may possibly lead to problems in the subsequent primary pure water apparatus and other processes, such as oxidation degradation of constitutional elements therein. In this regard, performing the reduction treatment allows such combined chlorine compounds to be harmless.

It is known that, if activated charcoal is used as the fixed bed of biologically supporting carriers in the biological treatment means 2, then the activated charcoal can perform reduction treatment for chlorine-based oxidizing agents due to catalytic reaction. However, the activated charcoal cannot rapidly reduce the combined chlorine compounds, which are thus easy to be leaked and may possibly remain to affect the subsequent primary pure water apparatus. Therefore, it is preferred that the reduction treatment means 4 is provided even if activated charcoal is used.

The above reduction treatment means 4 may for example be achieved by adding: gases such as hydrogen gas; lower oxides such as sulfur dioxide; lower oxygen acid salts such as thiosulfate, sulfite, bisulfite and nitrite; lower valent metal salts such as iron (II) salt; organic acids such as formic acid, oxalic acid and L-ascorbic acid or salts thereof; and other reducing agents such as hydrazine, aldehydes and sugars. Among them, nitrite, sulfite, iron (II) salt, sulfur dioxide or bisulfite, or oxalic acid, L-ascorbic acid or salts thereof, may be preferably used. In addition, an activated charcoal tower may be provided as the reduction treatment means 4, in which reduction is further performed by activated charcoal.

If a reducing agent is added, in which case the reducing agent is sodium sulfite, for example, then the adding amount thereof is preferably such that sulfite ion (SO₃²⁻) is equimolar to or more than hypochlorite ion (ClO⁻), and 1.2 times to 3.0 times of the amount may be added in consideration of safety factor. It is more preferred that the oxidizing agent concentration in the treated water, which may vary, is monitored and the reducing agent adding amount is controlled depending on the monitored oxidizing agent concentration. Alternatively, a simplified method may be used in which the oxidizing agent concentration is measured at fixed intervals and the adding amount is appropriately set in accordance with the measured concentration. Note that the detection means for the oxidizing agent concentration may be represented by oxidation-reduction potential (ORP) while that for the residual chlorine may be represented by residual chlorine meter (such as using polarographic method).

Specifically, if ammonium salt as the ammoniacal nitrogen source or other necessary source is added in a state where free chloride is present in the supply water (raw water) W for biological treatment, then the free chloride and the ammonium ion react to generate a combined chloride (chloramine) The combined chloride is difficult to be removed even by activated charcoal compared to the free chloride, thus leaking into the biologically treated water. Although the combined chloride is said as being a component that has lower oxidizing power relative to the free chloride, it is also known that the combined chloride re-generates free chloride due to an equilibrium reaction, and oxidation degradation may possibly be caused in the subsequent primary pure water treatment system etc.

In addition, slime control agent may be added to the raw water W treated in the biological treatment means 2. The slime control agent may be appropriately added as necessary for the purpose of avoiding problems (clogs in pipe works, slime obstructions such as increase in differential pressure, biofouling to RO membrane, etc.) caused in the subsequent treatment by bacteria bodies (released bacteria bodies from biological carriers) included in the treated water by the biological treatment means 2.

Further, a bacteria bodies separating apparatus may be used as necessary to remove bacteria bodies included in the treated water by the biological treatment means 2.

One or more of these treatments, such as addition of reducing agent and/or slime control agent and a treatment by the bacteria bodies treatment apparatus, may appropriately be performed depending on the water quality of the biological treated water from the biological treatment means 2, or may not be performed if the water quality is good.

According to the water treatment methods in the previously-described fifth and sixth embodiments, the treated water W1 can be obtained, from which urea has been highly decomposed/removed, and a pure water producing apparatus can be used to further treat the treated water W1 thereby to produce ultrapure water with extremely low urea concentration.

### Ultrapure Water Production Method

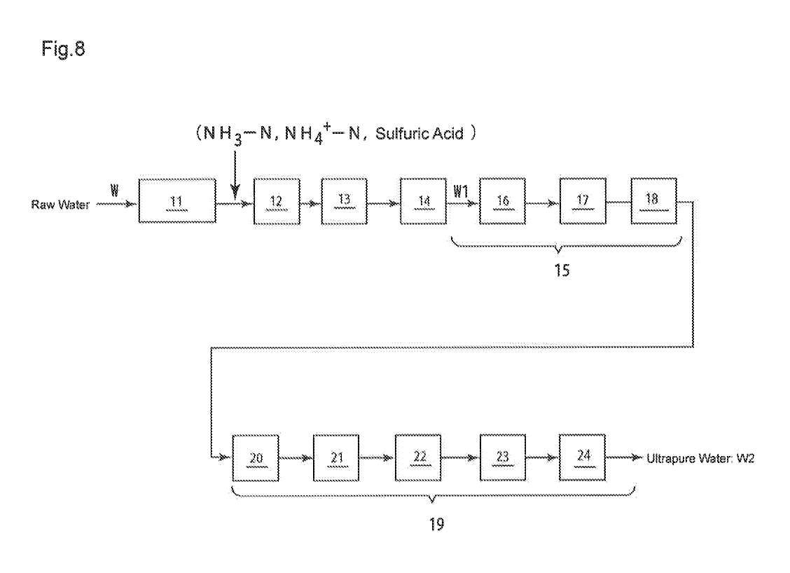

An ultrapure water production method, which utilizes any of the water treatment methods according to the aforementioned embodiments of the present invention, will then be described with reference to FIG. 8.

In this ultrapure water production method, raw water W is treated by a pretreatment system 11, biological treatment means 12, a bacteria bodies separating means 13 and a reducing means 14, and the treated water W1 is thereafter further treated by a primary pure water apparatus 15 and a sub-system (secondary pure water apparatus) 19. Note that examples of the bacteria bodies separating means 13 to be used include a filtration mechanism, a cartridge filter, an accurate filtration membrane separating apparatus, an ultrafiltration membrane separating apparatus and other appropriate components or apparatuses.

The primary pure water apparatus 15 is configured such that a first reverse osmotic (RO) membrane separating apparatus 16, a second reverse osmotic (RO) membrane separating apparatus 17 and a mixed-bed-type ion exchange apparatus 18 are arranged in this order. Note, however, that the apparatus configuration of this primary pure water apparatus 15 is not limited to the above configuration, and the primary pure water apparatus 15 may also be configured by either one of or appropriately combining two or more of a reverse osmotic membrane separating apparatus, an ion exchange treatment apparatus, an electrical deionization exchange apparatus, a UV oxidation treatment apparatus and other appropriate apparatuses.

The sub-system 19 is configured such that a sub-tank 20, a heat exchanger 21, a low-pressure ultraviolet rays oxidation apparatus 22, a mixed-bed-type ion exchange apparatus 23 and UF-membrane separating apparatus 24 are arranged in this order. Note, however, that the apparatus configuration of this sub-system 19 is not limited to the above configuration, and the sub-system 19 may also be configured by either one of or appropriately combining two or more of a de-aeration treatment apparatus, a UV oxidation treatment apparatus, an ion exchange treatment apparatus (non-regenerative type), an ultrafiltration membrane separating apparatus (fine particle removal) and other appropriate apparatuses.

An ultrapure water production method using such an ultrapure water production system will then be described. At first, the pretreatment system 11 is comprised of aggregation, pressurized flotation (precipitation) and filtration (membrane filtration) apparatuses and/or other appropriate apparatuses. This pretreatment system 11 removes suspended substances and colloidal substances in the raw water. In addition, this pretreatment system 11 is capable of removing polymer-type organic substances and hydrophobic organic substances etc.

The biological treatment means 12 performs the above-described biological treatment by adding, to the outflow water from the pretreatment system 11, urea or urea derivatives and/or ammoniacal nitrogen source (NH₃—N) and if necessary further adding, such as, sulfuric acid as the pH adjusting agent to adjust pH and oxidizing agent and/or disinfecting agent. The bacteria bodies separating means 13 located at the downstream side of the biological treatment means 12 separates/removes microorganism, carrier fine particles and other substances that flow out from the biological treatment means 12. This bacteria bodies separating means 13 may be omitted. The outflow water from the biological treatment means 12 may contain combined chlorine compounds as described above, and the reducing means 14 thus renders the combined chlorine compounds harmless. If the concentration of chlorine-based oxidizing agent in the raw water W is ignorable, then the addition of reducing agent in the reducing means 14 may be omitted because the outflow water from the biological treatment means 12 is unlikely to contain combined chlorine compounds.

The primary pure water apparatus 15 uses the first reverse osmotic (RO) membrane separating apparatus 16, the second reverse osmotic (RO) membrane separating apparatus 17 and the mixed-bed-type ion exchange apparatus 18 to remove ionic components and other components that remain in the treated water W1 from the biological treatment means 12.

Further, the sub-system 19 introduces the treated water from the primary pure water apparatus 15 into the low-pressure ultraviolet rays oxidation apparatus 22 via the sub-tank 20 and the heat exchanger 21 to ionize or decompose the TOC components contained therein. Among them, ionized organic substances are removed by the subsequent mixed-bed-type ion exchange apparatus 23. The treated water from this mixed-bed-type ion exchange apparatus 23 is further subjected to membrane separation treatment in the UF-membrane separating apparatus 24, and ultrapure water can thus be obtained.

According to the above ultrapure water production method, the biological treatment means 12 sufficiently decomposes/removes urea while the primary pure water apparatus 15 and the sub-system 19 arranged as the subsequent stages remove other TOC components, metal ions and other organic/inorganic components, and highly-pure ultrapure water can thereby efficiently be produced.

Moreover, according to the above ultrapure water production method, in order to remove turbid substances in the raw water W, the raw water W is introduced into the pretreatment system 11 before being introduced into the biological treatment means 12. Therefore, the decomposition/removal efficiency of urea in the biological treatment means 12 is prevented from deteriorating due to turbid substances, and the pressure loss in the biological treatment means 12 is also prevented from increasing due to turbid substances. Furthermore, according to this ultrapure water production method, the bacteria bodies separating means 13, the primary pure water apparatus 15 and the sub-system 19 are provided at the downstream side of the biological treatment means 12 thereby to present an advantageous effect that living organisms or carriers flowing out from the biological treatment means 12 can be removed by these bacteria bodies separating means 13, primary pure water apparatus 15 and sub-system 19 without any problem.

### EXAMPLES

### Example 1

The flow shown in FIG. 1 was used, and reagent urea (available from KISHIDA CHEMICAL Co., Ltd.) was added as necessary to city water (NOGI Town city water: average urea concentration 10 μg/L, average TOC concentration 500 μg/L).

In addition, the biological treatment means 2 was used in which a fixed bed was made by filling a cylindrical container with 10 L of granular activated charcoal (“Kuricoal WG160, 10/32 mesh” available from Kurita Water Industries Ltd) as biological carriers. Note that new charcoal was used as the granular activated charcoal in the biological treatment means 2.

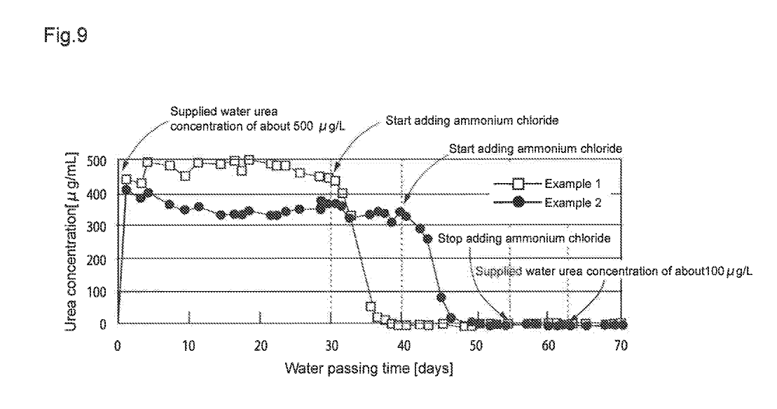

At first, raw water W was prepared by adding urea to the city water (no added reagent urea) so that the concentration was about 500 μg/L, and the raw water W was caused to pass through the biological treatment means 2 as downward flowing. Water passing speed SV was 20/hr (water passing flow volume per hour÷filled activated charcoal volume). Analysis of urea concentration was performed over 70 days for the biologically treated water after the water passing. Results thereof are shown in FIG. 9. Note that reverse washing was performed during 10 minutes once a day in the above water passing treatment. The reverse washing was performed such that the biologically treated water was caused to pass from the lower portion of the cylindrical container to the upper portion as upward flowing with LV=25 m/hr (water passing flow volume per hour÷cylindrical container cross-section area).

Procedure in the analysis of urea concentration is as follows. At first, total chlorine residue concentration of water sample is measured by the DPD method, and reduction treatment is performed using an equivalent amount of sodium bisulfate (the total chlorine residue concentration is thereafter measured again by the DPD method to be confirmed as being less than 0.02 mg/L). This water sample having been subjected to the reduction treatment is then caused to pass through ion exchange resin (“KR-UM1” available from Kurita Water Industries Ltd) with SV 50/hr to be subjected to deionization treatment before being condensed 10 to 100 times using a rotary excavator, and the urea concentration is quantitatively determined by the diacetylmonoxime method.

Note that pH adjustment was not performed during the water passing test period. The pH during the test period was within a range of 6.8 to 7.5. Note also that the water temperature of the city water was lower than 15° C. during the test period, and a temperature control bath was therefore provided as a preceding stage to the biological treatment means 2 to supply thereto water heated to within a range of 20° C. to 22° C. Note further that the adjustment of the dissolved oxygen concentration was not performed because, during the test period, the dissolved oxygen (DO) concentration in the raw water W was 6 mg/L or more, the dissolved oxygen concentration in the treated water W1 from the biological treatment means 2 was 2 mg/L or more, and the dissolved oxygen was determined to be sufficient.

As apparent from FIG. 9, during 25 days from the start of water passing without addition of ammoniacal nitrogen source, the urea concentrations of the supplied water and the biologically treated water were substantially the same value (about 500 μg/L), and urea was not observed to be removed.

Thereafter, on the 25th day from the start of water passing, ammonium chloride (available from KISHIDA CHEMICAL Co., Ltd.) as the ammoniacal nitrogen source was started to be added to the raw water W so that the ammonium ion concentration would be about 1 mg/L (NH₄⁺ equivalent).

As a result, effective removal of urea was observed on the 30th day from the start of water passing, the removability of urea was improved due to the continuation of water passing, and a urea concentration in the biologically treated water of 2 μg/L or less was achieved on the 40th day from the start of water passing (about 2 weeks after the start of adding ammonium chloride).

Even thereafter the urea concentration in the biologically treated water was maintained to be 2 μg/L or less, so the addition of ammonium chloride was stopped on the 55th day from the start of water passing and the urea concentration in the supplied water was changed from 500 μg/L to 100 μg/L on the 62th day from the start of water passing, but the urea concentration in the biologically treated water still remained 2 μg/L or less thus not being observed to vary. This appears to be because the addition of ammonium chloride causes bacteria bodies to grow and improves the activity thereof, and the number of bacteria and the activity can be maintained even after the stop of addition of ammonium chloride. It is thereby supposed that sufficient effect can be obtained even if the addition of ammoniacal nitrogen source represented by ammonium chloride is performed only at the time of start-up or intermittently performed, for example.

### Example 2

The water passing test was performed in a similar manner to that of Example 1 except for using biological treatment means 2 in which domestication had already been carried out using reagent urea to develop the urea-decomposing ability such that urea in the biologically treated water was 2 μg/L or less to 100 μg/L of urea in the supplied water, and analysis of urea concentration was performed over 70 days. Results thereof are also shown in FIG. 9.

As apparent from FIG. 9, after the fourth day from the start of water passing, the urea concentration in the treated water W1 was observed to have a tendency of slightly decreasing, but hovering around 350 μg/L.

Thereafter, on the 40th day from the start of water passing, ammonium chloride was started to be added under the same condition as Example 1.

As a result, on the 50th day from the start of water passing (10 days after the start of adding ammonium chloride), the urea concentration in the biologically treated water was achieved to be 2 μg/L or less.

Even thereafter the urea concentration in the biologically treated water was maintained to be 2 μg/L or less, so the addition of ammonium chloride was stopped on the 55th day from the start of water passing and the urea concentration in the supplied water was changed from 500 μg/L to 100 μg/L on the 62th day from the start of water passing, but the urea concentration in the biologically treated water still remained 2 μg/L or less thus not being observed to vary.

These results of Example 1 and Example 2 have revealed that the addition of ammoniacal nitrogen source allows urea to be removed from the raw water W.

### Example 3

The flow shown in FIG. 3 was used, and reagent urea (available from KISHIDA CHEMICAL Co., Ltd.) was added as necessary to well water (YOSHIDA Town groundwater: average urea concentration 5 μg/L or less, average TOC concentration 0.3 mg/L, ammonium ion<0.1 mg/L or less) to provide simulated raw water (raw water W). Note that the reason why the well water was used as raw water was to simulate natural water having a moderate concentration of salts and not containing urea and ammoniacal nitrogen.

In addition, the biological treatment means 2 was used in which a fixed bed was made by filling a cylindrical container with 2 L of granular activated charcoal (“Kuricoal WG160, 10/32 mesh” available from Kurita Water Industries Ltd) as biological carriers. Note that the granular activated charcoal to be used in the biological treatment means 2 was such that domestication had already been carried out using reagent urea to develop the urea-decomposing ability.

At first, raw water W was prepared by adding urea to the well water to be of a concentration of about 100 μg/L. Water temperature of the raw water W was within a range of 13° C. to 17° C., and a heat exchanger was therefore used to heat the raw water W within a range of 20° C. to 22° C. In addition, the raw water W was subjected to air aeration to have a dissolved oxygen (DO) concentration of 6 to 8 mg/L in order to ensure sufficient dissolved oxygen concentration.

The raw water W was caused to pass through the biological treatment means 2 as downward flowing. Water passing speed SV was 20/hr (water passing flow volume per hour÷filled activated charcoal volume). The urea concentration and the ammoniacal nitrogen source were analyzed over one week for the biologically treated water (W1) after the water passing to calculate their average values. Results thereof are shown in Table 1 along with the urea concentration and the average concentration of ammoniacal nitrogen source in the raw water W (supplied water). Note that reverse washing was performed during 10 minutes once a day in the above water passing treatment. The reverse washing was performed such that the biologically treated water was caused to pass from the lower portion of the cylindrical container to the upper portion as upward flowing with LV=25 m/hr (water passing flow volume per hour÷cylindrical container cross-section area).

Then, raw water W was prepared by adding urea to the well water to be of a concentration of about 10 μg/L, and the urea concentration and the ammoniacal nitrogen source were analyzed over four weeks (the first week to the fifth week) for the biologically treated water (W1) after the water passing to calculate their average values. Results thereof are shown in Table 1 along with the urea concentration and the average concentration of ammoniacal nitrogen source in the raw water W (supplied water).

Further, raw water W was prepared by adding urea again to the well water to be of a concentration of about 100 μg/L, and the urea concentration and the ammoniacal nitrogen source were analyzed over one week (the fifth week to the sixth week) for the biologically treated water (W1) after the water passing to calculate their average values. Results thereof are shown in Table 1 along with the urea concentration and the average concentration of ammoniacal nitrogen source in the raw water W (supplied water).

Note that pH adjustment was not performed during the water passing test period. The pH during the test period was within a range of 6.8 to 7.5.

Procedure in the analysis of urea concentration is as follows. At first, total chlorine residue concentration of water sample is measured by the DPD method, and reduction treatment is performed using an equivalent amount of sodium bisulfite (the total chlorine residue concentration is thereafter measured again by the DPD method to be confirmed as being less than 0.02 mg/L). This water sample having been subjected to the reduction treatment is then caused to pass through ion exchange resin (“KR-UM1” available from Kurita Water Industries Ltd) with SV 50/hr to be subjected to deionization treatment before being condensed 10 to 100 times using a rotary excavator, and the urea concentration is quantitatively determined by the diacetylmonoxime method.

[symbol]

Table 1

Table 1 and analysis results of data revealed that the continuous water passing treatment during the first one week, wherein the urea concentration in the simulated raw water W was adjusted to about 100 μg/L using reagent urea, resulted in such a stability as being 2 μg/L or less of the urea concentration in the treated water from the biological treatment means 2. Then, the urea concentration in the simulated raw water W was adjusted to about 10 μg/L, and the continuous water passing treatment during the subsequent four weeks was performed, resulting in such a stability as being 2 μg/L or less of the urea concentration in the biologically treated water. Thereafter, the urea concentration in the simulated raw water W was adjusted to about 100 μg/L using reagent urea, and the continuous water passing treatment during the subsequent one week was performed, resulting in such a stability as being 40 μg/L or less of the urea concentration in the biologically treated water, and significant change (tendency of improving or degrading in the urea removability) was not observed during the one week. These results show that adding a small amount of urea allows the urea removability to be maintained with some extent.

### Example 4

Test was performed in a similar manner to that of Example 3 except for adding ammonium chloride (available from KISHIDA CHEMICAL Co., Ltd.) as the ammoniacal nitrogen source to be about 0.5 mg/L in addition to urea throughout the entire period. Results thereof are also shown in Table 1.

Table 1 and analysis results of data revealed that the continuous water passing treatment from the first to fifth weeks, wherein urea and ammonium chloride were added to be of about 10 μg/L and 0.5 mg/L, respectively, resulted in such a stability as being 2 μg/L or less of the urea concentration in the biologically treated water. In addition, the continuous water passing treatment from the fifth to sixth weeks, wherein the urea concentration in the simulated raw water W was adjusted again to about 100 μg/L using reagent urea, also resulted in such a stability as being 2 μg/L or less of the urea concentration in the biologically treated water. These results show that adding a small amount of urea and ammoniacal nitrogen source allows the urea removability to be highly maintained. Note that significant difference was not observed in the removability for ammonium chloride as the ammoniacal nitrogen during the test period, and the ammoniacal nitrogen concentration in the treated water was less than 0.1 mg/L relative to about 0.5 mg/L of ammonium chloride in the supplied water.

### Comparative Example 1

Test was performed in a similar manner to that of Example 3 except for not adding urea and ammoniacal nitrogen source during the period from the first week to the fifth week. Results thereof are also shown in Table 1.

Table 1 and analysis results of data revealed that the continuous water passing treatment from the first to fifth weeks, wherein urea and ammonium chloride were not added, resulted in such a stability as being 2 μg/L or less of the urea concentration in the biologically treated water. In addition, the continuous water passing treatment from the fifth to sixth weeks, wherein the urea concentration in the simulated raw water W was adjusted again to about 100 μg/L using reagent urea, resulted in such a stability as being 80 μg/L or less of the urea concentration in the biologically treated water, and significant change (tendency of improving or degrading in the urea removability) was not observed during the one week.

From the aforementioned results, it has been confirmed that adding urea or urea derivatives and ammoniacal nitrogen source to the raw water W allows the urea removability to be maintained even if the urea concentration in the raw water W varies, particularly when the concentration increases after a period of low concentration. This appears to be because urea and ammoniacal nitrogen are added thereby to allow for maintaining the minimum amount of bacteria bodies which require them as feeding sources, even in a period where the urea concentration in the raw water W decreases.

### Example 5

As the simulated raw water W to be used, city water (NOGI Town city water: average urea concentration 10 μg/L, average TOC concentration 500 μg/L, ammonium ion concentration of less than 0.1 mg/L) was appropriately added thereto with reagent urea (available from KISHIDA CHEMICAL Co., Ltd).

In an apparatus having the configuration shown in FIG. 5, the biological treatment means 2 was used in which a fixed bed was made by filling a cylindrical container with 2 L of granular activated charcoal (“Kuricoal WG160, 10/32 mesh” available from Kurita Water Industries Ltd) as biological carriers. Note that new charcoal as the granular activated charcoal in the biological treatment means 2 was immersed, after being washed, into 2 L of city water added thereto with 200 mL of nitrification sludge and filled therewith, and the water passing was thereafter started.

Water temperature of the city water was within a range of 25° C. to 28° C. and pH was within a range of 6.5 to 7.5 during the test period, and a heat exchanger was therefore used to adjust the temperature of the simulated raw water W to be about 25° C. In such a biological treatment apparatus, the simulated water 1 was pretreated in the pretreatment system 7 and then added thereto with sulfuric acid from the supply means 6 so that the pH of the simulated raw water was within a range of about 6.0 to 6.5, while ammonium chloride (available from KISHIDA CHEMICAL Co., Ltd.) as the ammoniacal nitrogen source was added thereto so that the ammonium ion concentration became about 0.5 mg/L (NH₄⁺ equivalent). The raw water W containing these additives was caused to pass through the biological treatment means 2 as downward flowing. Water passing speed SV was 20/hr (water passing flow volume per hour÷filled activated charcoal volume). Note that reverse washing was performed during 10 minutes once a day in the above water passing treatment. The reverse washing was performed such that the biologically treated water was caused to pass from the lower portion of the cylindrical container to the upper portion as upward flowing with LV=25 m/hr (water passing flow volume per hour÷cylindrical container cross-section area).

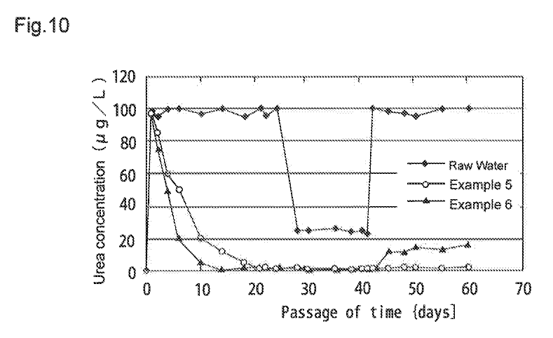

Under the above-described water passing condition, continuous water passing of the raw water W was performed during 60 days, and analysis of the urea concentration in the treated water was performed. In this case, water passing was performed during the first 27 days with urea concentration of about 100 μg/L in the raw water W, then from the 28th day to the 41st day (14 days) with urea concentration of about 25 μg/L in the raw water W, and further from the 42nd day again with urea concentration of about 100 μg/L in the raw water W. Results thereof are shown in FIG. 10 along with the variation of urea concentration in the raw water.

Procedure in the analysis of urea concentration is as follows. At first, total chlorine residue concentration of water sample is measured by the DPD method, and reduction treatment is performed using an equivalent amount of sodium bisulfite (the total chlorine residue concentration is thereafter measured again by the DPD method to be confirmed as being less than 0.02 mg/L). This water sample having been subjected to the reduction treatment is then caused to pass through ion exchange resin (“KR-UM1” available from Kurita Water Industries Ltd) with SV 50/hr to be subjected to deionization treatment before being condensed 10 to 100 times using a rotary excavator, and the urea concentration is quantitatively determined by the diacetylmonoxime method.

As apparent from FIG. 10, in Example 5 wherein the ammoniacal nitrogen source was added and the pH was adjusted within a range of about 6.0 to 6.5, the urea concentration in the treated water became 2 μg/L or less on the 21st day from the start of water passing, and this concentration was able to be maintained even if the urea concentration in the raw water W was increased again to 100 μg/L during the period from the 42nd day.

### Example 6

Treatment for raw water W was performed in a similar manner to that of Example 5 except for adjusting the pH of the raw water W within a range of 7.0 to 7.5. Continuous water passing of this raw water W was performed during 60 days, and analysis of the urea concentration in the treated water was performed. Results thereof are also shown in Table 1.

As apparent from FIG. 10, in Example 6 wherein the ammoniacal nitrogen source was added and the pH was adjusted within a substantially neutral range of about 7.0 to 7.5, the urea concentration in the treated water became 2 μg/L on the 21st day from the start of water passing, but the urea concentration in the raw water W was increased again to 100 μg/L during the period from the 42nd day, so that the urea concentration in the treated water rose to 10 μg/L or more, and this concentration remained around 10 μg/L even thereafter during the period. Note that the ammoniacal nitrogen source added during this period was confirmed to completely be converted to nitric acid.

By applying such a biological treatment apparatus to producing ultrapure water, an ultrapure water production method can be obtained which can highly removes urea in the raw water.

### EXPLANATION OF REFERENCE NUMERALS

1 . . . water supply reservoir
2 . . . biological treatment means
3 . . . primary pure water apparatus
4 . . . reduction treatment means
6 . . . supply means
7 . . . pretreatment system
11 . . . pretreatment system
12 . . . biological treatment means
14 . . . reducing means
15 . . . primary pure water apparatus
19 . . . sub-system (secondary pure water apparatus)
W . . . raw water
W1 . . . treated water

1. A water treatment method for biologically treating raw water that contains an organic substance, the water treatment method comprising:
adding urea or a urea derivative and/or an ammoniacal nitrogen source to the raw water; and
thereafter performing a biological treatment for the raw water.

2. The water treatment method as set forth in claim 1, further comprising adjusting pH within a range of 5 to 6.5 to perform the biological treatment after adding the urea or the urea derivative and/or the ammoniacal nitrogen source to the raw water.

3. The water treatment method as set forth in claim 1, wherein the ammoniacal nitrogen source is such that a NH₄+—N/urea is 100 or less relative to a concentration of the urea.

4. The water treatment method as set forth in claim 1, wherein the ammoniacal nitrogen source is ammonium salt.

5. The water treatment method as set forth in claim 1, wherein the biological treatment is performed by a biological treatment means that has a biologically supporting carrier.

6. The water treatment method as set forth in claim 5, wherein the biological treatment is performed by a biological treatment means that has a fixed bed of the biologically supporting carrier.

7. The water treatment method as set forth in claim 5, wherein the biologically supporting carrier is an activated charcoal.

8. The water treatment method as set forth in claim 1, further comprising performing a reduction treatment after the biological treatment.

9. An ultrapure water production method comprising:
obtaining treated water through the water treatment method as set forth in claim 1; and
treating the treated water by a primary pure water apparatus and a secondary pure water apparatus to produce ultrapure water.

10. The water treatment method as set forth in claim 2, wherein the ammoniacal nitrogen source is such that a NH₄+—N/urea is 100 or less relative to a concentration of the urea.

11. The water treatment method as set forth in claim 2, wherein the ammoniacal nitrogen source is ammonium salt.

12. The water treatment method as set forth in claim 3, wherein the ammoniacal nitrogen source is ammonium salt.

13. The water treatment method as set forth in claim 2, wherein the biological treatment is performed by a biological treatment means that has a biologically supporting carrier.

14. The water treatment method as set forth in claim 3, wherein the biological treatment is performed by a biological treatment means that has a biologically supporting carrier.

15. The water treatment method as set forth in claim 4, wherein the biological treatment is performed by a biological treatment means that has a biologically supporting carrier.

16. The water treatment method as set forth in claim 6, wherein the biologically supporting carrier is an activated charcoal.

17. The water treatment method as set forth in claim 2, further comprising performing a reduction treatment after the biological treatment.

18. The water treatment method as set forth in claim 3, further comprising performing a reduction treatment after the biological treatment.

19. The water treatment method as set forth in claim 4, further comprising performing a reduction treatment after the biological treatment.

20. The water treatment method as set forth in claim 5, further comprising performing a reduction treatment after the biological treatment.
